(19) United States
(12) Patent Application Publication
(10) Pub. No.: US 2017/0124739 A1
(43) Pub. Date: May 4, 2017

(54) USER INTERFACE DESIGN FOR CHART NAVIGATION AND SELECTION

(71) Applicant: International Business Machines Corporation, Armonk, NY (US)

(72) Inventors: Rolando Perez, Poughkeepsie, NY (US); Christopher A. Robbins, Monroe Twp, NY (US)

(21) Appl. No.: 15/072,991

(22) Filed: Mar. 17, 2016

Related U.S. Application Data
(63) Continuation of application No. 14/932,333, filed on Nov. 4, 2015.

(51) Int. Cl. G06T 11/20; G06F 3/0484; G06F 3/0488

(52) U.S. Cl. CPC G06T 11/206; G06F 3/0488; G06F 3/04842; G06T 2200/24

(57) ABSTRACT

A computer-implemented method of generating a graphical user interface (GUI) element for chart navigation and selection is provided. The computer-implemented method includes determining that a chart including chart elements that are expandable is to be displayed on a first portion of a touchscreen, generating the GUI element including GUI element sections respectively corresponding to each of the chart elements, displaying the chart and the GUI element in the first and a second portion of the touchscreen, respectively, and linking the GUI element with the chart such that first and second user actions relative to the GUI element and one of the GUI element sections, respectively, cause a corresponding navigation modification of the chart and a corresponding expansion of the corresponding one of the chart elements, respectively.

### CROSS-REFERENCE TO RELATED APPLICATION

This application is a continuation of and claims the benefit or priority to U.S. application Ser. No. 14/932,333, which was filed on Nov. 4, 2015. The entire contents of U.S. application Ser. No. 14/932,333 are incorporated herein by reference.

### BACKGROUND

The present invention relates to a user interface and, more specifically, to a user interface design for chart navigation and selection.

Today, it is common for applications that gather large amounts of data, such as systems monitoring application (e.g., IBM's zAware application), to graphically display incoming information. For example, the application may display bar graphs and pie charts with each section associated with otherwise hidden detailed information. That is, for a given bar graph, each bar may be associated with detailed information that is accessed and viewed by the user clicking on that specific section. This is known as “drilling down.”

Many computing devices, whether they are static or mobile computing devices, rely on the human finger for pointing and selecting. This is particularly true of mobile devices, such as tablets and smartphones. However, in the case of tablets and smartphones in particular, a user's finger may be thicker than a part of the graph. Thus, selection of a bar in a bar graph or a slice in a pie chart can be difficult and imprecise and may lead to a usability problem with the monitoring application as a whole, as shown in FIG. 1. Indeed, for the case of the smartphone 1 of FIG. 1, the user's finger 2 may be much wider than all of the various bars 3 the user may wish to individually select.

Presently, there are two solutions available for dealing with the problem noted above. One is to permit the user to zoom in on a particular part of the graphical display by pinching out or holding his finger over a specific graphical area. In both cases, the action causes the graphical display to zoom into the corresponding section but can be cumbersome and results in less data being visible during the zoom event, especially if the zoom is off target. A second solution relies on the user's use of an external device, such as a stylus or mouse, to provide more precise pointing and selection. The problem with this solution is that the most commonly used smart phones and tablets do not use styluses and it is uncommon for a typical user to have access to any kind of external pointing device.

### SUMMARY

According to an embodiment of the present invention, a computer-implemented method of generating a graphical user interface (GUI) element for chart navigation and selection is provided. The computer-implemented method includes determining that a chart including chart elements that are expandable is to be displayed on a first portion of a touchscreen, generating the GUI element including GUI element sections respectively corresponding to each of the chart elements, displaying the chart and the GUI element in the first and a second portion of the touchscreen, respectively, and linking the GUI element with the chart such that first and second user actions relative to the GUI element and one of the GUI element sections, respectively, cause a corresponding navigation modification of the chart and a corresponding expansion of the corresponding one of the chart elements, respectively.

According to another embodiment of the present invention, a computing system for generating a graphical user interface (GUI) element for chart navigation and selection is provided. The computing system includes a touchscreen, a processing unit and a memory having executable instructions stored thereon. When executed, the executable instructions cause the processing unit to determine that a chart including chart elements that are expandable is to be displayed on a first portion of the touchscreen, generate the GUI element including GUI element sections respectively corresponding to each of the chart elements, display the chart and the GUI element in the first and a second portion of the touchscreen, respectively, and link the GUI element with the chart such that first and second user actions relative to the GUI element and one of the GUI element sections, respectively, cause a corresponding navigation modification of the chart and a corresponding expansion of the corresponding one of the chart elements, respectively.

According to another embodiment of the present invention, a computer program product for generating a graphical user interface (GUI) element for chart navigation and selection is provided. The computer program product includes a computer readable storage medium having program instructions embodied therewith, which are readable and executable by a processing circuit to cause the processing circuit to determine that a chart including chart elements that are expandable is to be displayed on a first portion of a touchscreen, generate the GUI element including GUI element sections respectively corresponding to each of the chart elements, display the chart and the GUI element in the first and a second portion of the touchscreen, respectively, and link the GUI element with the chart such that first and second user actions relative to the GUI element and one of the GUI element sections, respectively, cause a corresponding navigation modification of the chart and a corresponding expansion the corresponding one of the chart elements, respectively.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of a conventional graphical user interface (GUI);

FIG. 2 is a perspective view of a smartphone in accordance with embodiments;

FIG. 3 is a schematic diagram of components of the smartphone of FIG. 2;

FIG. 4 is a flow diagram illustrating a computer-implemented method of generating a graphical user interface (GUI) element for chart navigation and selection in accordance with embodiments;

FIG. 5 is a schematic illustration of a GUI element in accordance with embodiments;

FIG. 6 is a schematic illustration of a GUI element in accordance with embodiments;

FIG. 7 is a schematic illustration of a GUI element in accordance with alternative embodiments; and

FIG. 8 is a schematic illustration of a GUI element in accordance with further embodiments.

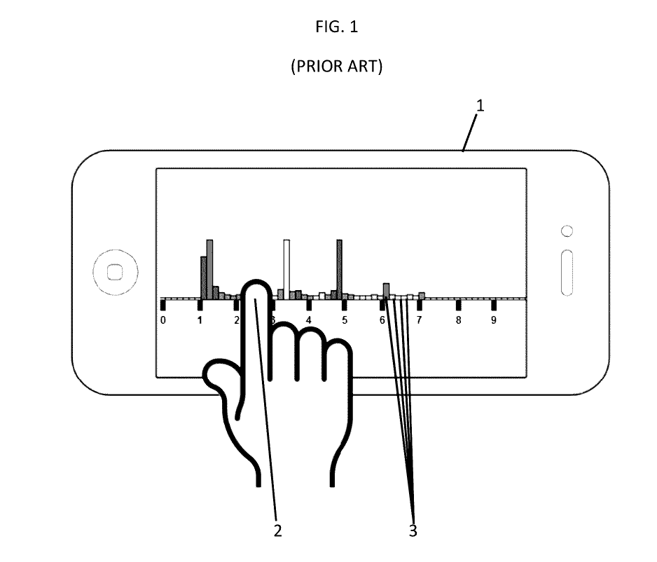

### DETAILED DESCRIPTION

As will be described below, a dedicated graphical user interface (GUI) element is displayable proximate to a chart with a control pointer. A user can drag or tap onto this control pointer in order to highlight individual chart elements. The user can also hold down on the control pointer to select a corresponding chart element. The dedicated GUI element has a default zoom that is never changed and therefore always maximizes data in the chart that can be seen. The dedicated GUI element requires no panning or pinching for performing a selection and does not require a user's finger to cover the chart and has no need for an external pointing device, such as a stylus for precision taping and selection.

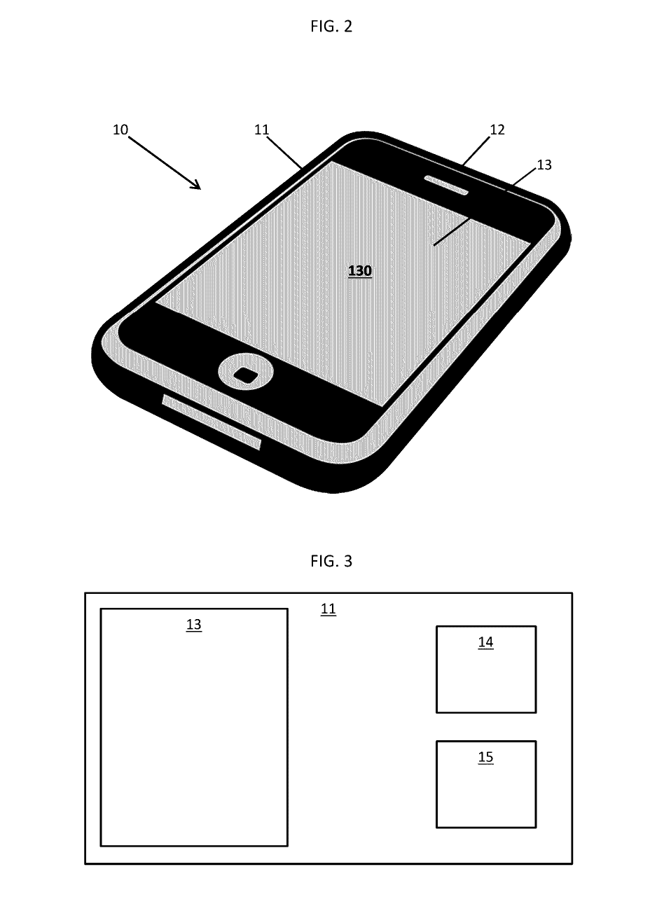

With reference now to FIGS. 2 and 3, a computing system 10 for generating a graphical user interface (GUI) element for chart navigation and selection is provided. The computing system 10 may be embodied as a mobile computing device, such as a smartphone 11, a tablet, a laptop computer or another similar computing device. In the case of the computing system 10 being embodied as a smartphone 11, the computing system 10 includes a housing 12, a touchscreen 13, a processing unit 14 (see FIG. 3) and memory 15 (see FIG. 3). The housing 12 forms the exterior surface and structure of the smartphone 11 and supports the touchscreen 13. The touchscreen 13 is provided as a generally flat surface on which at least one or more graphical user interfaces (GUI) 130 and other information and data are displayable. The processing unit 14 may be provided as one or more central processing units or circuits and serves as the computational hub for the smartphone 11. The memory 15 may be provided as any type of random access, read/write or read only memory and, in any case, has executable instructions stored thereon. When executed, those executable instructions cause the processing unit 14 to perform the actions and method described herein.

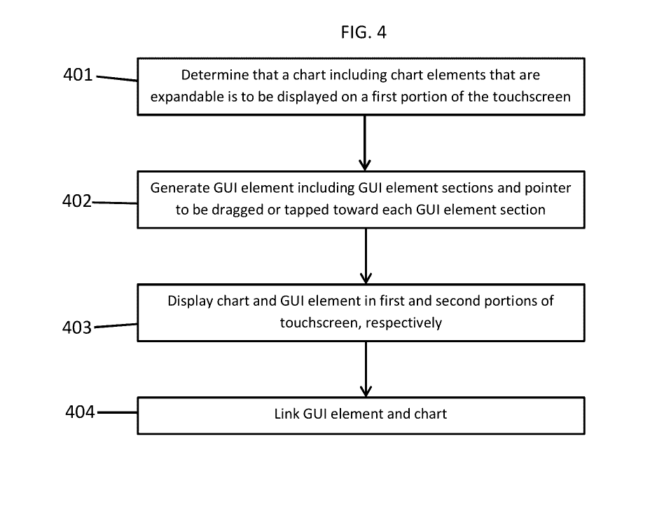

In accordance with embodiments and, with reference to FIGS. 4-7, when executed, the executable instructions cause the processing unit 14 to determine at block 401 that a chart 20, which includes chart elements 201 that are drillable down into (or graphically or informationally expandable), is to be displayed on a first portion 131 of the touchscreen 13. When executed, the executable instructions further cause the processing unit 14 to generate the GUI element 30 at block 402 such that the GUI element 30 includes discrete or continuous GUI element sections 301 and a pointer 302, which is configured to be dragged or tapped along the GUI element 30 toward each of the GUI element sections 301, and to display the chart 20 and the GUI element 30 at block 403 in the first portion 131 of the touchscreen 13 and in a second portion 132 of the touchscreen 13, which is remote from the first portion 131, respectively. In addition, when executed, the executable instructions cause the processing unit 14 to link the GUI element 30 with the chart 20. By way of this linkage, a first user action relative to the GUI element 30 causes a corresponding navigation modification of the chart 20 and a second user action relative to one or more of the GUI element sections 301 causes a corresponding drill down into or expansion (graphic or informational) the corresponding one of the chart elements 201.

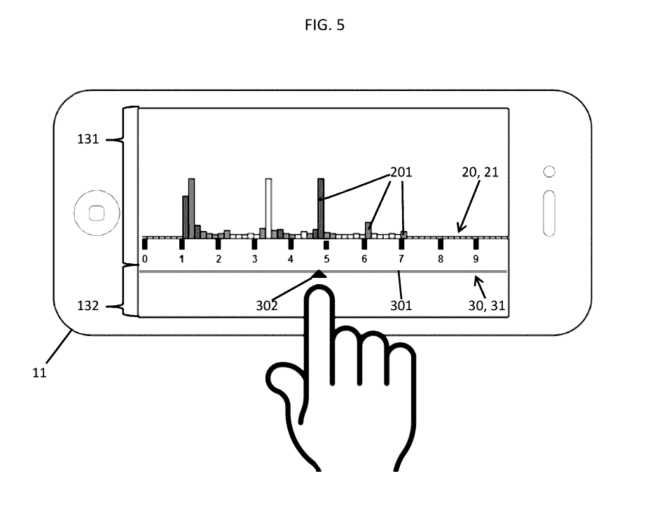

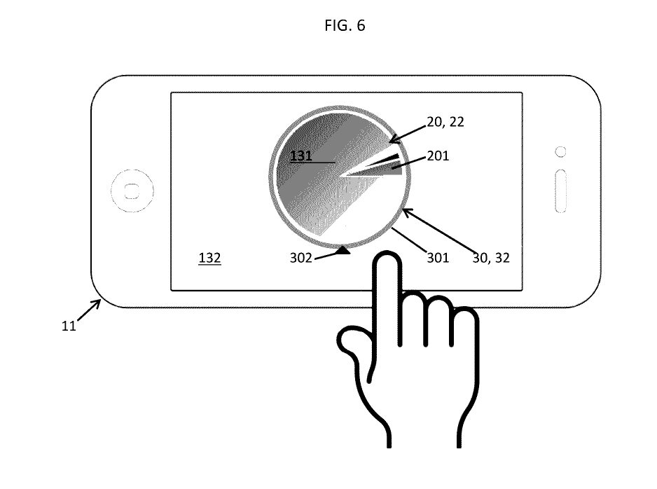

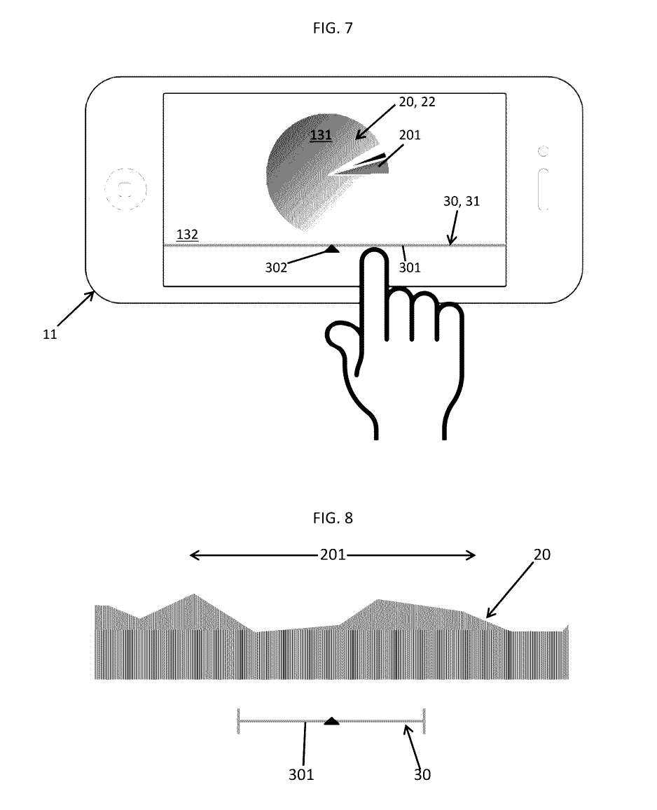

In accordance with embodiments, the chart 20 and the GUI element 30 may have similar shapes as in FIGS. 5 and 6 or dissimilar shapes as in FIG. 7. For example, the chart 20 may be presented as a bar graph 21 (see FIG. 5), a pie chart 22 (see FIGS. 6 and 7) or some other similar graphical display. Meanwhile, the GUI element 30 may be presented as a linear selector 31 (see FIGS. 5 and 7) or a curvilinear selector 32.

Where the chart 20 is presented as the bar graph 21 (e.g., a horizontal bar graph) and the GUI element 30 is presented as the linear selector 31, as shown in FIG. 5, the chart elements 201 may be provided as the bars of the bar graph 21 and the linear selector 31 may be displayed below and in parallel with the bar graph 21. The GUI element sections 301 in this case may be arranged in a linear sequence along the linear selector 31 such that each GUI element section 301 corresponds in terms of linear position to one of the chart elements 201. When the pointer 302 is positioned at a given one of the GUI element sections 301, the corresponding one of the chart elements 201 (i.e., in terms of linear position) is highlighted or selectable.

Conversely, where the chart 20 is presented as the pie chart 22 and the GUI element 30 is presented as the curvilinear selector 32, as shown in FIG. 6, the chart elements 201 may be provided as the wedges of the pie chart 22 and the curvilinear selector 32 may be displayed circumferentially about the pie chart 22. The GUI element sections 301 in this case may be arranged in a circumferential sequence along the curvilinear selector 32 such that each GUI element section 301 corresponds in terms of radial position to one of the chart elements 201. When the pointer 302 is positioned at a given one of the GUI element sections 301, the corresponding one of the chart elements 201 (i.e., in terms of radial position) is highlighted or selectable.

Where the chart 20 is presented as the pie chart 22 and the GUI element 30 is presented as the linear selector 31, as shown in the dissimilar case of FIG. 7, the chart elements 201 may be provided as the wedges of the pie chart 22 and the linear selector 31 may be displayed below the pie chart 22. The GUI element sections 301 in this case may be arranged in a linear sequence along the linear selector 31 such that each GUI element section 301 corresponds in terms of its linear position to the corresponding radial position of one of the chart elements 201. When the pointer 302 is positioned at a given one of the GUI element sections 301, the corresponding one of the chart elements 201 (i.e., in terms of a linear-to-radial position relationship) is highlighted or selectable.

In accordance with embodiments in which the GUI element 30 is presented as the linear selector 31, the first user action may be taken as a dragging or a tapping of the pointer 302. The dragging of the pointer 302 is executable by a user placing his finger on or near the pointer 302 and dragging or swiping this finger along the touchscreen in forward or reverse directions along the GUI element 30. The tapping of the pointer 302 is executable by the user tapping one side of the GUI element 30 or the other with each tap corresponding to the pointer 302 advancing from one chart element 201 to an adjacent chart element 201. In either case, the user's finger remains in the second portion 131 of the touchscreen 13 so as to avoid blocking or obscuring any part of the chart 20.

In accordance with embodiments in which the GUI element 30 is presented as the curvilinear selector 32, the first user action may be taken as a dragging or a tapping of the pointer 302. The dragging of the pointer 302 is executable by a user placing his finger on or near the pointer 302 and dragging or swiping this finger along the touchscreen in forward or reverse directions about the GUI element 30. The tapping of the pointer 302 is executable by the user tapping one side of the GUI element 30 or the other with each tap corresponding to the pointer 302 advancing from one chart element 201 to an adjacent chart element 201. In either case, the user's finger remains in the second portion 131 of the touchscreen 13 so as to avoid blocking or obscuring any part of the chart 20.

Whether the GUI element 30 is presented as the linear selector 31 or the curvilinear selector 32, the chart element 201 associated with the GUI element section 301 that is currently pointed to by the pointer 302 may be highlighted, enlarged or otherwise brightened. In any case, the second user action may be taken by the user (e.g., once the desired chart element 201 is highlighted) as a secondary hold-down of the user's finger on the corresponding one of the GUI element sections 301. After a predefined hold-down time, the processing unit 14 will recognize the second user action as having been taken and generate a corresponding drill down or expansion command. This drill down or expansion command will result in the display of the information or data associated with the chart element 201 that has been selected and expanded.

In accordance with further embodiments and, with reference to FIG. 8, the GUI element 30 need not have a same or similar granularity or scale as the chart 20. Thus, where the chart 20 has a multitude of chart elements 201 and the GUI element 30 has a corresponding multitude of GUI element sections 301, the GUI element 30 may be presented on the second portion 131 of the touchscreen 13 at a different scale from that of the chart 20. As such, where the chart 20 may include, for example, hundreds of chart elements 201 along an entirety of a horizontal axis, the GUI element 30 may be presented with only 10 or so GUI element sections 301. In these or other similar cases, the hidden sections of the GUI element 30 and the hidden GUI element sections 301 are accessible by continued dragging or tapping of the pointer 302. That is, the user may drag the pointer 302 to one side of the visible section of the GUI element 30 and then keep his finger in place so that the GUI element 30 effectively slides underneath the pointer 302 until the user reaches the desired, formerly hidden sections of the GUI element 30.

In accordance with embodiments, the chart 20 and the chart elements 201 may be defined by an application and from application data, respectively. The application may be provided, for example, as an enterprise computing system monitoring application or another similar type of monitoring application and may be stored in the memory 15 or be otherwise accessible to the processing unit 14. In the exemplary case of the application being the enterprise computing system monitoring application, the application monitors various aspects of computing performance of a given enterprise computing system into which the application is deployed. The application thus generates large amounts of data as a result of such monitoring and is configured to present the generated data in graphical form as the chart 20 and the chart elements 201.

When the application is prepared to present the generated data in graphical form as the chart 20 and the chart elements 201 and where the application includes the executable instructions described above, the processing unit 14 generates the GUI element 30, displays the chart 20 and the GUI element 30 and links the GUI element 30 with the chart 20.

In accordance with alternative embodiments, the chart 20 and the chart elements 201 may be identifiable from graphics rendering code, such as HTML. In these cases, the processing unit 14 may identify when the user is browsing the Internet on a page in which the chart 20 is to be displayed. Here, if the user's browser includes a plug-in that has the executable instructions described above, the processing unit 14 will generate the chart 20 and the chart elements 201 and will display the chart 20 and the GUI element 30 in the browser and link the GUI element 30 with the chart 20.

Advantages associated with the computer program product and method described above include, but are not limited to, the fact that the features described herein can work without explicit notions of ‘best-practices’ or pre-existing lists of metrics since important factors that are generally included in the creation of such best-practices or lists are codified within the time series scoring mechanisms. Thus, from day 1 of a product deployment, data selection can be explicitly facilitated and can deal with vagaries of a particular environment (i.e., where a metric type X, based upon observation and analysis, is determined to be acceptable in one environment but would not be in another). In addition, administrators or users of the computer program product and method will be able to select the top-N sets of the time-series data and have confidence that the set is a “best” fit for a given case.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method of generating a graphical user interface (GUI) element for chart navigation and selection, the computer-implemented method comprising:
determining that a chart comprising chart elements that are expandable is to be displayed on a first portion of a touchscreen;
generating the GUI element comprising GUI element sections respectively corresponding to each of the chart elements;
displaying the chart and the GUI element in the first and a second portion of the touchscreen, respectively; and
linking the GUI element with the chart such that first and second user actions relative to the GUI element and one of the GUI element sections, respectively, cause a corresponding navigation modification of the chart and a corresponding expansion of the corresponding one of the chart elements, respectively.

2. The computer-implemented method according to claim 1, wherein the chart is defined by an application and the chart elements are one of defined from application data and identified from graphics rendering code.

3. The computer-implemented method according to claim 1, wherein the chart comprises a bar graph and the GUI element comprises a linear selector and pointer.

4. The computer-implemented method according to claim 1, wherein the chart comprises a pie chart and the GUI element comprises a curvilinear selector and pointer.

5. The computer-implemented method according to claim 1, wherein the chart and the GUI element have dissimilar shapes.

6. The computer-implemented method according to claim 1, wherein the chart and the GUI element have dissimilar granularities or scales.

7. The computer-implemented method according to claim 1, wherein the first user action comprises a user navigational action and the second user action comprises a user selection action.
